(19) United States
(12) Patent Application Publication
(10) Pub. No.: US 2005/0080732 A1
(43) Pub. Date: Apr. 14, 2005

(54) Internet payment and security system

(76) Inventors: Marc Georges Warin, Katoomba (AU); Allan Whitbread, Katoomba (AU)

Correspondence Address: SEYFARTH SHAW, 55 EAST MONROE STREET, SUITE 4200, CHICAGO, IL, 60603-5803, US

(21) Appl. No.: 10/490,328

(22) PCT Filed: Sep. 20, 2002
(86) PCT No.: PCT/AU02/01289

(30) Foreign Application Priority Data
Sep. 20, 2001 (AU) 2001100395

(51) Int. Cl. G06F 17/60

(52) U.S. Cl. 705/40

(57) ABSTRACT

A system is described for enabling a user to make Internet purchases utilising a transfer of a pre-determined credit to an on-line account from an existing service provider to that user. In use, a user dials a telephone number from a telephone and authorises a charge onto their utility or service provider bill in consideration for the transfer of credit to their account associated with the Internet payment system. The customer can then go to a participating merchant's website, make their selections of goods and/or services and complete the transaction by clicking on a payment button associated with the system of the present invention and the credit is transferred between accounts. An instantaneous communication is issued to the merchant and to the user to advise that the transaction has been successfully completed. An associated system for age verification to vet access to an Internet website is also described.

### FIELD OF THE INVENTION

This invention relates to a payment method and system and particularly to a payment method and system which can be used to make secure payments over the Internet.

### BACKGROUND OF THE INVENTION

Numerous businesses, companies, and other organisations provide websites on the Internet, also known as the World Wide Web, and offer various goods and services for purchase. Irrespective of the size of the transaction, many Internet users do not have access to a payment method that allows secure, spontaneous, anonymous purchases (particularly small purchases or “micro-payments”) from Internet-enabled devices.

Currently, most purchases made over the Internet must be made using a credit card or bank account. If a potential customer for those goods or services does not have a credit card, or is uncomfortable transmitting their credit card or bank account details over the Internet because of security concerns, then presently they will not be able to make Internet purchases. A second problem with the use of credit card or bank account based Internet Payment Methods (IPMs) is that they cannot generally be used to make very small payments, referred to as “micro-payments”, which are used to pay for pieces of information instead of entire subscriptions to services. Often, electronic retailers (or “e-tailers”) cannot accept these micro-payments as the credit card fees associated with the transactions are greater than the e-tailer's margins. Also, for the customer, using a credit card for small transactions can be inconvenient and unjustifiable.

Pre-paid IPMs, where the user purchases a token and electronically transfers the stored-value of the token to an Internet account, have not been successful in the market place because of the need for a distribution network, the lack of security, and their cumbersome methodologies.

E-tailers and Internet advertisers/marketers have attempted to use incentive or loyalty programs as rewards for participating in on-line surveys and the like. However, the absence of a widely accepted Internet currency and limited participation has made it difficult for users to accumulate enough reward points to redeem them for purchases. The cash value of individual reward points is so small that the processing fees and distribution costs make it difficult for the promoter to pay participants.

Another challenge posed by the Internet is to keep minors from accessing objectionable material or purchasing products that are intended for age-of-majority users, without impinging on the rights of adults to freely do so. With countless websites being added everyday, the world wide web is too large an entity for any organisation to monitor and is not limited by geography or other physical boundaries. The ability to re-locate websites or change their name makes it impossible for authorities to be certain that cited websites have been removed.

Also, society has been unable to accurately define what information and images are objectionable and what are harmful. This ambiguity leads to many websites claiming they do not need to restrict minor access as they do not contain “objectionable” material by certain standards. Some legislation aimed at protecting children from objectionable content has been deemed a violation of adult civil liberties.

The existing methodologies used to restrict the access by minors to age-of-majority websites (net filters, ISP-based filters, disclaimers, paid membership in ID verification systems, and opt-in programs) either fail to offer sufficient protection or are so strict as to preclude legitimate users. Internet filters can screen out objectionable words or other material from the computers that have the software installed, however, other computers can still be used to access the material. Internet filters are notoriously flawed in that they can be fooled into letting through objectionable material, or they can inadvertently exclude acceptable material. Putting the onus for filtering out objectionable material on the Internet Service Providers is prohibitively expensive for most ISPs and is therefore unlikely.

Most adult content websites make a cursory attempt to control access by posting a disclaimer on the home page of the site. In order to enter the site, the customer must click a button to confirm that they are of the age of majority. Although this requires active participation on the part of the customer, it in no way restricts access or verifies the age of the user.

After disclaimers, paid memberships are the next most popular age verification method. It is based on the assumption that in order to have a credit card, a user must be over a certain legal age. Of course, this provides no verification that the user is of age, or that the user is in fact the account holder. Many people object to paying for this “service” and, moreover, are concerned about providing their credit card details over the Internet as well as issues of anonymity.

### SUMMARY OF THE INVENTION

In a first aspect the present invention provides a system for making payments over the Internet, the system including:
a database for storing account details and account balances of users of the system;
means for a user to establish a user-name and account in the database;
means for transferring to the user's account in the database a pre-determined amount of credit from an existing service provider to the user;
means for allowing the transfer of credit from the pre-determined amount to an account of an Internet-enabled merchant, another user account or an external account or credit facility, wherein the means for transferring credit to the user's account operates independently of the means for allowing the transfer of credit.

When the term “user name” is used herein, it can refer to an account number, an account name or some other identifier of the user.

Preferably the means for a user to establish a user-name and account includes telephony or the Internet.

Preferably the means for transferring a pre-determined amount of credit is an electronic transfer. Most preferably the electronic transfer is arranged by the user calling a telephone number or using a website to deliver transfer instructions. Even more preferably the telephone number is a premium rate telephone number.

Preferably the system includes a computer navigable site such as a web site through which the user can access their account and view transaction details.

Preferably the user account is password-protected.

Preferably the external account or credit facility includes a phone bill, a pre-paid card, a utility bill, a credit card, or a bank account.

Preferably the account of an Internet-enabled merchant on the database is used to accept a transfer of credit from purchasers for goods or services available from that merchant.

Preferably the means to allow the transfer of credit from a user's account to the account of an Internet-enabled merchant is initiated by the sending of an instantaneous communication from a merchant website to the database once a user has elected to purchase goods or services from the website of the merchant.

Preferably once the transfer of credit has been approved and completed, an instantaneous communication is sent to the user and/or to the merchant to confirm the transfer.

Preferably the transfer of credit is in the amount of a nominated purchase price from the merchant.

Preferably the user account on the system can be utilised as a means of determining whether a user is of appropriate age to be allowed to view the contents of a given Internet website.

Preferably the system includes any means of accessing the system via standard telephones; mobile phones, including digital, 3G, or WAP-enabled mobile phones; personal digital assistants; computers; interactive television; point of sale terminals; or any other means for accessing the Internet.

In a second aspect the present invention provides a method for making payments over the Internet including the steps of:
a user authorising a transfer of credit to an account associated with that user on an Internet-accessible database and the making of a corresponding charge to a service provider to the user;
the user accessing a merchant website that is participant in the Internet payment method, selecting a good or service for purchase from that website and indicating a wish to pay;
transferring credit from the user account to the merchant account so as to purchase the good or service, wherein the step of authorising a transfer of credit to the user account occurs independently of the step of transferring credit from the user account.

Preferably the transfer of credit is preceded by the user submitting appropriate password information in order to be able to access the user account.

Preferably the method of the second aspect includes any one of the features of the system defined in the first aspect.

In a third aspect the present invention provides a system for age verification to vet access to a website of an Internet-enabled merchant or content provider, the system including:
a database for storing personal details including the age of users of the system;
means for a user to establish a user-name and the personal details in the database;
means to compare the user-name and personal details established by the user in the database by communication between an external service provider to the user, and the database;
means for the Internet-enabled merchant or content provider to confirm the user name and personal details by referring to the database to confirm or deny access to the user of the website.

Preferably the means for a user to establish a user-name and entry details includes telephony and/or the Internet.

Preferably the system includes a computer navigable site such as a web site through which the user can access the database for viewing and entering personal details.

Preferably the user account is password-protected.

In a fourth aspect the present invention provides a method for age verification'to vet access to a website of an Internet-enabled merchant or content provider including the steps of:
a user establishing a user-name and their personal details including their age on an Internet-accessible database;
the user accessing a merchant or other content provider website that is a participant in the age verification method;
the merchant or other content provider website contacting the database to confirm the user name and personal details and to confirm or deny access to the user of the website, wherein the confirmation of user-name and personal details on the database is given by a comparison with the user-name and personal details provided by an existing external service provided to the user, which is in communication with the database.

Preferably the establishment of user-name and entry details on the database involves using telephony and/or the Internet. Most preferably the external service provider is a telephone utility.

Preferably the method of the fourth aspect includes any one of the features of the system defined in the third aspect.

### BRIEF DESCRIPTION OF THE DRAWINGS

The present invention will now be described by way of example only and with reference to the accompanying drawings in which:

FIG. 1 is a flow chart illustrating the operation of the system of making payments over the Internet of the present invention.

FIG. 2 is a flow chart illustrating the operation of the system of age verification to vet access to an Internet website of the present invention.

### DETAILED DESCRIPTION OF PREFERRED EMBODIMENTS

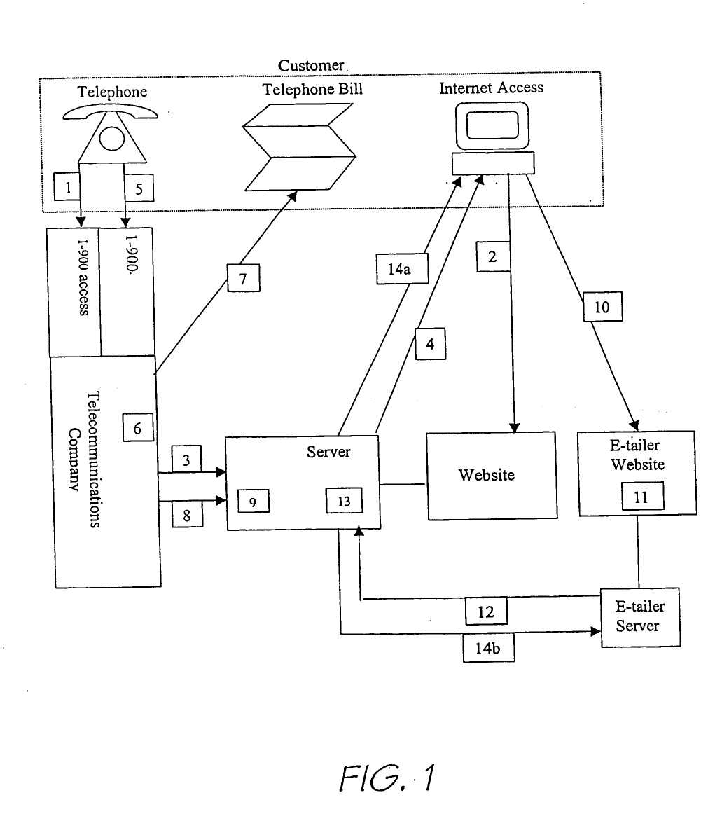

Referring to FIG. 1, a preferred form of a system for making payments over the Internet is shown. In order to use the system, a customer or user first obtains premium rate telephone number access (eg. 1-900 numbers) from their telecommunications company, obtaining a PIN code (1).

Next the customer goes to the website (2) associated with the Internet payment system and establishes an account on that website by providing their name, address, phone number and email address. This information is compared to the information provided when the customer requested premium rate number access (3) and, when verified, the customer is provided with an account number, a user name, and a password (4).

To credit money to its account, the customer calls a premium rate telephone number (5), enters their PIN code and authorises a transfer of credit to their account and an associated charge (the “drop-charge”) on their telephone bill. The telecommunications company verifies the user's account details (6), applies the drop-charge to the customer's telephone bill (7) and sends an instantaneous communication to the Internet payment system web server (8) including the customer's account number, telephone number and the value of the account credit. The customer's account is then updated at the web server (9).

In order to make a purchase using the payment system, a customer goes to a participating merchant's website (10), selects the product or service they wish to purchase, and clicks on the payment system button on the website. A payment window then opens, with the purchase total inserted, and a customer fills in their account number, user name, and password and clicks submit (11). An instantaneous communication, incorporating the payment window and the merchant's details, is sent to the payment system web server (12). Payment is then transferred from the customer's account at the payment system web server (13) to the merchant's account at the payment system web server. Once the transaction has been approved and completed, an instantaneous communication is sent to the customer (14a) and the merchant (14b) to confirm the sale.

At the end of the month, the user pays the telecommunications company for their telephone bill, including the amounts charged to the telephone bill via the payment system. The telecommunication company then forwards the amounts charged to the payment system operator who in turn pays the participating merchants for their portion of the transaction/s.

It is also envisaged that customers of the system of the present invention can also use the system to make purchases in conventional shops and premises with merchants who have Internet access at their premises.

It is also envisaged that customers of the system may establish sub-accounts for other individuals and set limits on the credit available through those sub-accounts. This feature can be used by parents, for example, to limit the amount of money available to their children to spend on-line and also to limit the potential for fraudulent use of the system.

The system can also provide the ability to transfer the balance of a customer's account to an offline medium such as a pre-paid credit storage card, telephone card or the like. These pre-paid cards can be used as payment means at traditional merchant's stores and the account holders can transfer some or all of the balance to the card and take the card into a merchant's store to effect a purchase.

The sale of selected pre-paid cards at retailers, is also envisaged, where a person buying such a card can go to the website, establish an account, and transfer the balance of the pre-paid card to that account. Thus, someone who was in a country but did not have a telephone (such as a traveller, backpacker) can transfer credit onto the system in order to make a purchase.

It is also envisaged that the system can transfer credit from any utility or service provider that maintains a billing relationship with users, such as, but not limited to, an electric company, gas company, water supplier, or Internet service provider (ISP). In such an embodiment, the user establishes an account with the system as already described. To add credit to the account, the user then calls the service provider/utility (most likely through a regular cost phone number) and identifies themselves as a person having authorised access to the service provider/utility account. Once verified, the user requests that a pre-determined amount be charged to their utility or service provider bill and that the corresponding amount of credit be applied to their on-line account on the system. The utility, after satisfying itself of the credit risk, notifies the system server via electronic transmission that the corresponding amount of credit is applied to the user's account. The system updates the user's account to reflect this request. Purchases and reconciliation can then proceed in the manner already described.

It is envisaged that the method for transferring credit from the service provider (telephone company in one embodiment or electric, gas, water, or ISP in other embodiments) can be accessed via a standard telephone number. Whereas premium rate telephone numbers can be used only to charge a pre-determined amount to the user's phone bill, conventional telephone numbers can be used to authorise charges to other service provider bills, as already described.

The payment system described in the foregoing embodiments has a number of advantages over existing Internet payment methods. Firstly, the system does not require the customer to have a credit card and, therefore, those users who do not have a credit card, or who do not wish to disclose their credit card details over the Internet, can use the system.

The system is also easily accessible and useable by the consumer who can transfer credit to the Internet account at any time of the day from their home telephone, and can then access the credit from any Internet-enabled device. This provides a greater degree of access and spontaneity than other existing non-credit card based Internet payment methods.

The system of the present invention is also secure, articularly when compared to credit card based Internet payment methods which are susceptible to fraud during the transmission of the details of a customer's card and during storage of those details. The present system provides a simple security system in which only one entity, the user, has complete access. The other entities involved in the transactions only have access to the keys required to complete their portion of the transaction. Thus, if the security of one of the entities is compromised, the other entities remain unaffected.

Further security is derived from the fact that credit can only be added to the account from the telephone of the account holder, and that if an unauthorised person gains access to the Internet account, they can spend only the balance left on the account and no more. This contrasts with credit cards where an unauthorised user can debit the account until the credit limit is reached, or the card is cancelled.

Pre-paid Internet payment methods store the user's balance on a card, chit, or token. The price of goods purchased is then either deducted from the balance, or, in some cases, the balance is transferred to an online account. However, in the first instance, this means that the user must have the card with them to make a purchase. In the second instance, the card may be lost or stolen before the balance is transferred. An account as part of the preferred payment system of the invention cannot be lost or stolen because the credit is instantly applied to the account from the premium rate (eg. 1-900 number). That account is also portable in that the user does not need to have a card or receipt to access the account. A user of the proposed system is only required to remember their user name, password and account number.

The preferred embodiments of the payment system described are very suited for micro-payments because the user pays the telephone company the full amount of the credit and can then spend that credit in any denominations. Merchant fees are based on the total monthly volumes, so the merchants are not precluded from conducting transactions of any value. The unique two-stage design of payment system also enables the user to transfer credit onto the account in their domestic currency and effect purchases across international borders through a simple currency conversion. Thus, the payment system can be accepted on any Internet website.

The preferred embodiments of the payment system described allow the user to make purchases with complete anonymity, without jeopardising the merchant's payments or exposing the telephone company or other service provider to bad-debt. When a user opens a payment system account, the telephone company knows who the user is and is therefore assured of payment. The drop-charge appears on the telephone bill, but individual transactions with Internet e-tailers are recorded separately on the customer's account, where only the account holder can view them. Moreover, because the merchant is receiving the payment form a trusted third party (the telephone company), the customer can provide aliases or post office box addresses to the merchant for the delivery of goods and the merchant can send the purchased items to any address without fear of non-payment. Also, the payment system payment window only requires that the customer enter their Account Number, User Name, and Password. Thus, no personal details are transmitted across the net or relayed to the merchant.

Furthermore, because the accounts can only be issued to the adult lessor of the telephone line, then only adults are able to access sites that offered this payment method. The system can be used as a non-discriminatory age verification method for age-of-majority websites because it is not necessary to carry a credit on the account. Minors in a given household can still be able to use their accounts (established on their behalf by the adult lessor of the phone) to access suitable websites and make purchases, but they are unable to enter restricted sites.

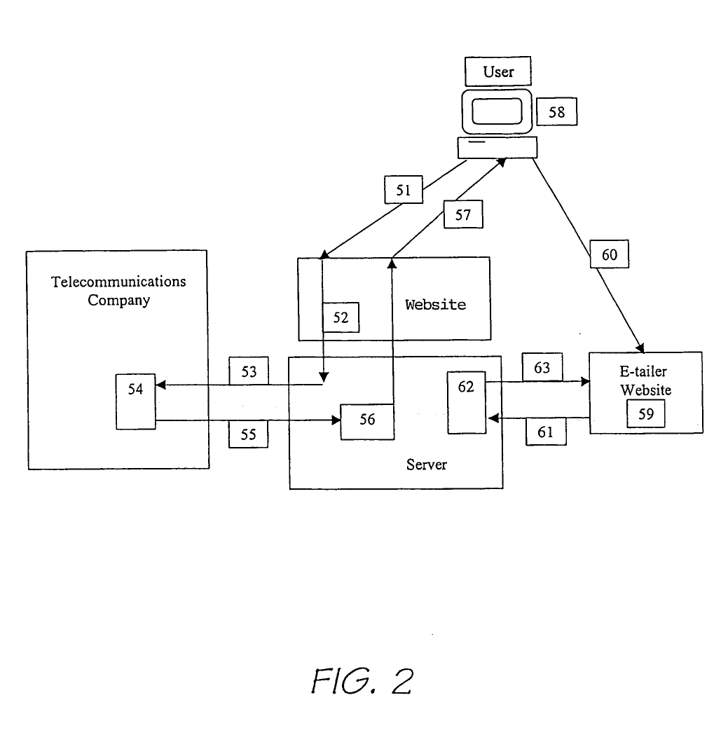

Referring now to FIG. 2, a preferred form of a system of age verification to vet access to an Internet website is shown. An Internet user establishes an account by visiting the system website (51) and filling out the online form (52). When the user clicks submit, the details are forwarded to the user's telephone company (53) to confirm that the user is the owner of the telephone account and is an adult (54), since only adults can have a phone account. Upon receiving verification from the telephone company (55), the system server activates the account (56), providing the user with an account number, username, and password (57). The user can now set-up sub accounts for members of the household and designate each as age of minority or age of majority (58). The user's account is, by default, an age of majority account.

In use, the system icon (ie. which indicates that the age verification system is in place) can be displayed on the entry page of a merchant's website (59). A user who wants to enter the website clicks on the icon (60), enters their user name and password, and clicks submit. These details are forwarded to the system server (61) which verifies that the user has an age of majority account (62) and returns a message to the merchant's website confirming that the user is allowed to enter (63). Accounts with an age-of-minority designation can, of course, return a message to the merchant's site to refuse entry.

In other embodiments of the system, the establishment of user name and personal details and therefore age verification can be made by way of the applicant directly contacting the database in person and providing details, or via information provided by another external service provider which can confirm age of the user. For example these can include Government departments (eg. motor registry or taxation departments) or utilities other than a telephone company which hold personal client information. As will be appreciated, the contact with the external service provider or utility to provide confirmation of personal details need only be a one-off event.

This system overcomes at least some of the inadequacies of the current age verification systems, and includes a number of features that make it appealing to the users, web merchants, the government, and civil libertarians. Minors are able to use the payment system but still be barred from purchasing at “age of majority” e-tailers. Since minors cannot have telephone accounts, the account holder in the household with an account can establish sub-accounts for various family members. The sub-accounts can be flagged as “age of majority” or “age of minority” so that only the former can be used to purchase from adult-content sites. The master account holder can delegate the credit in the master account to the sub-accounts as necessary, thereby imposing a controllable limit on the spending of sub-account holders. The PIN code requirements for access to the payment system premium rate telephone number ensure that only the owner of the telephone line is authorized. Thus, children are only able to access the system if their parents give them the PIN code.

Because the age verification system uses the telephone account to determine whether an individual is of the age of majority, it is, by definition, available to all Internet users (minors get their account from their parents). Also, because there is no cost to the user to establish an account, and there is no requirement to keep a balance on the account, the system does not discriminate on the basis of money. As the verification system uses an existing telephone infrastructure it can be operated on an international basis.

The verification system provides anonymity for the user in two ways. Firstly, the website is not given any information about the user, other than the fact that he/she is old enough to visit the site. Secondly, the user is not identified as potentially wanting access to adult content.

Because the system is user-specific, not computer-specific, it affords the same level of protection no matter what computer is used to access the Internet and parents can determine what kind of access their children have irrespective of what computer they use to access the Internet. It is envisioned that the system may also be able to incorporate a rating system for websites similar to the film/literature classification scheme.

As the system is user-specific, it does not need to consider the content of the website in order to make its determination. This eliminates the problem of non-objectionable websites being restricted because of some flaw in the filter as well as eliminating the dependency on any particular interpretation of “objectionable material”. The right of individuals to publish any manner of legal content is preserved because the verification system does not censor the content of the web, but rather controls who has access to certain sites. In short, no adult is precluded from viewing any material on the web.

It is to be understood that, if any prior art information is referred to herein, such reference does not constitute an admission that the information forms a part of the common general knowledge in the art, in Australia or any other country.

Whilst the invention has been described with reference to a number of preferred embodiments it should be appreciated that the invention can be embodied in many other forms.

1. A system for making payments over the Internet, the system including:
a database for storing account details and account balances of users of the system;
means for a user to establish a user-name and account in the database;
means for transferring to the user's account in the database a pre-determined amount of credit from an existing service provider to the user;
means for allowing the transfer of credit from the pre-determined amount to an account of an Internet-enabled merchant, another user account or an external account or credit facility, wherein the means for transferring credit to the user's account operates independently of the means for allowing the transfer of credit.

2. A system as claimed in claim 1 wherein the means for a user to establish a user-name and account includes telephony or the Internet.

2. A system as claimed in claim 1 wherein the means for transferring a pre-determined amount of credit is an electronic transfer.

3. A system as claimed in claim 3 wherein the electronic transfer is arranged by the user calling a telephone number or using a website to deliver transfer instructions.

4. A system as claimed in claim 4 wherein the telephone number is a premium rate telephone number.

5. A system as claimed in claim 1 which includes a computer navigable site such as a web site through which the user can access their account and view transaction details.

6. A system as claimed in claim 1 which includes a computer navigable site such as a web site through which the user can access their account and view transaction details.

7. A system as claimed in claim 1 wherein the user account is password protected.

8. A system as claimed in claim 1 wherein the external account or credit facility includes a phone bill, a pre-paid card, a utility bill, a credit card, or a bank account.

9. A system as claimed in claim 1 wherein the account of an Internet-enabled merchant on the database is used to accept a transfer of credit from purchasers for goods or services available from that merchant.

10. A system as claimed in claim 1 wherein the means to allow the transfer of credit from a user's account to the account of an Internet-enabled merchant is initiated by the sending of an instantaneous communication from a merchant website to the database once a user has elected to purchase goods or services from the website of the merchant.

11. A system as claimed in claim 10 wherein once the transfer of credit has been approved and completed, an instantaneous communication is sent to the user and/or to the merchant to confirm the transfer.

12. A system as claimed in claim 10 wherein the transfer of credit is in the amount of a nominated purchase price from the merchant.

13. A system as claimed in claim 1 wherein the user account on the system is utilised as a means of determining whether a user is of appropriate age to be allowed to view the contents of a given Internet website.

14. A system as claimed in claim 1 which includes any means of accessing the system via standard telephones; mobile phones, including digital, 3G, or WAP-enabled mobile phones; personal digital assistants; computers; interactive television; point of sale terminals; or any other means for accessing the Internet.

15. A method for making payments over the Internet including the steps of:—a user authorising a transfer of credit to an account associated with that user on an Internet-accessible database and the making of a corresponding charge to a service provider to the user;—the user accessing a merchant website that is participant in the Internet payment method, selecting a good or service for purchase from that website and indicating a wish to pay; transferring credit from the user account to the merchant account so as to purchase the good or service.

16. A method as claimed in claim 14 wherein the transfer of credit is preceded by the user submitting appropriate password information in order to be able to access the user account.

17. A method as claimed in claim 15 which includes the features of the system defined in claim 1.

18. A system for age verification to vet access to a website of an Internet-enabled merchant or content provider, the system including: a database for storing personal details including the age of users of the system; means for a user to establish a user-name and the personal details in the database; means for the Internet-enabled merchant or content provider to confirm the user name and personal details by referring to the database to confirm or deny access to the user of the website.

19. A system as claimed in claim 18 wherein the means for a user to establish a user-name and entry details includes telephony and/or the Internet.

20. A system as claimed in claim 18 which includes a computer navigable site such as a web site through which the user can access the database for viewing and entering personal details.

21. A system as claimed in claim 18 wherein the user account is password-protected.

22. A method for age verification to vet access to a website of an Internet-enabled merchant or content provider including the steps of:—a user establishing a user-name and their personal details including their age on an Internet-accessible database;—the user accessing a merchant or other content provider website that is a participant in the age verification method;—the merchant or other content provider website contacting the database to confirm the user name and personal details and to confirm or deny access to the user of the website.

23. A method as claimed in claim 22 wherein the establishment of user-name and entry details on the database involves using telephony and/or the Internet.

24. A method as claimed in claim 22 wherein the confirmation of user-name and personal details on the database is given by an external service provider contacted by the database.

25. A method as claimed in claim 24 wherein the external service provider is a telephone utility.
